(19) United States
(12) Patent Application Publication
(10) Pub. No.: US 2010/0125518 A1
(43) Pub. Date: May 20, 2010

(54) SYSTEM AND METHOD FOR FACILITATING EXCHANGE OF CREDIT DEFAULT SWAPS

(75) Inventor: Farooq Jaffrey, London (GB)

Correspondence Address: DARBY & DARBY P.C., P.O. BOX 770, Church Street Station, New York, NY, 10008-0770, US

(73) Assignee: TRACCR LIMITED, London (GB)

(21) Appl. No.: 12/331,569

(22) Filed: Dec. 10, 2008

(30) Foreign Application Priority Data
Nov. 14, 2008 (GB) 0820925.6

(51) Int. Cl. G06Q 40/00

(52) U.S. Cl. 705/37

(57) ABSTRACT

A system and method for facilitating the exchange of credit default swaps identifies one of a plurality of users accessing a client processing device. Data representative of tendered credit instruments and offer prices from a plurality of tender processing devices is received at a server processing device. The server processing device determines from user data whether sufficient credit is available to the identified user for the purchase of a selected quantity of the tendered credit instrument. If sufficient credit for the identified user does exist the selected tendered credit instrument is transferred by instructing a payment clearance of the payment transaction, electronically signing an electronic credit default swap contract on behalf of the user and the buyer or seller of the tendered credit instrument and transmitting the credit default swap contract to the tender processing device and client processing device.

### CROSS REFERENCE TO RELATED APPLICATIONS

The present application claims priority to Great Britain Application No. 0820925.6 filed Nov. 14, 2008. The entirety of the application is incorporated herein by reference.

### FIELD OF THE INVENTION

The present invention relates to a system and method for facilitating exchange of credit default swaps, in particular the exchange of credit default swaps between a tender device and a client device.

### BACKGROUND OF THE INVENTION

A credit default swap (CDS) is a contract in which a buyer of the CDS agrees to make a series of payments to a seller and, in exchange, receives a payoff if a credit instrument, for example a bond or loan, goes into default or a specified credit event occurs, for example bankruptcy or restructuring. Credit default swaps can be bought by a professional investor and traded amongst a group of well-established investors; it is not necessary for a particular buyer to own the underlying credit instrument. Currently, credit default swaps are traded directly between buyers and sellers which limits the availability and ease of trading amongst the group of investors who are typically large financial institutions. In the context of this application, an institution is an individual or organisation (e.g. a bank or fund) which carries out CDS trading. Large financial institutions are generally content to trade credit default swaps amongst each other because there is awareness amongst the investors of the credit worthiness of the counter party. However, this limits the availability of CDS trades to direct trades between institutions who have detailed knowledge of the credit worthiness of the individual institutions; that is the ability of an individual institution owning a particular CDS to be held to the payoff of the credit instrument on the occurrence of the specified credit event. Generally, this means that individual investors, who are not well-known or visibly involved in CDS trades, cannot trade in CDS.

It would be desirable to improve the ease and availability of trades in defaults swaps employing electronic trading platforms.

### SUMMARY OF THE INVENTION

The present invention is defined by the appendant claims and aims to solve the aforementioned problems.

The system and method of the present invention increases the availability and ease of access to credit default swap trades amongst individuals whilst ensuring that CDS trades are only effected when the credit worthiness of the individuals can be verified to an acceptable level; that is a level at which it is presumed the buyer will not default on the trade subsequent to its completion and the seller will not default on a payout if the credit event covered by the CDS occurs.

### BRIEF DESCRIPTION OF THE DRAWINGS

The present invention will now be described by way of reference to the accompanying drawings in which:

FIG. 1 shows a credit default swap trading system that exists in the prior art;

FIG. 2 shows a credit default swap trading system according to the present invention;

FIG. 3 shows a workflow of the credit default trading system of FIG. 2;

FIG. 4 shows a user interface generated at a client processing device of the credit default trading system of FIG. 2.

### DETAILED DESCRIPTION OF THE DRAWINGS

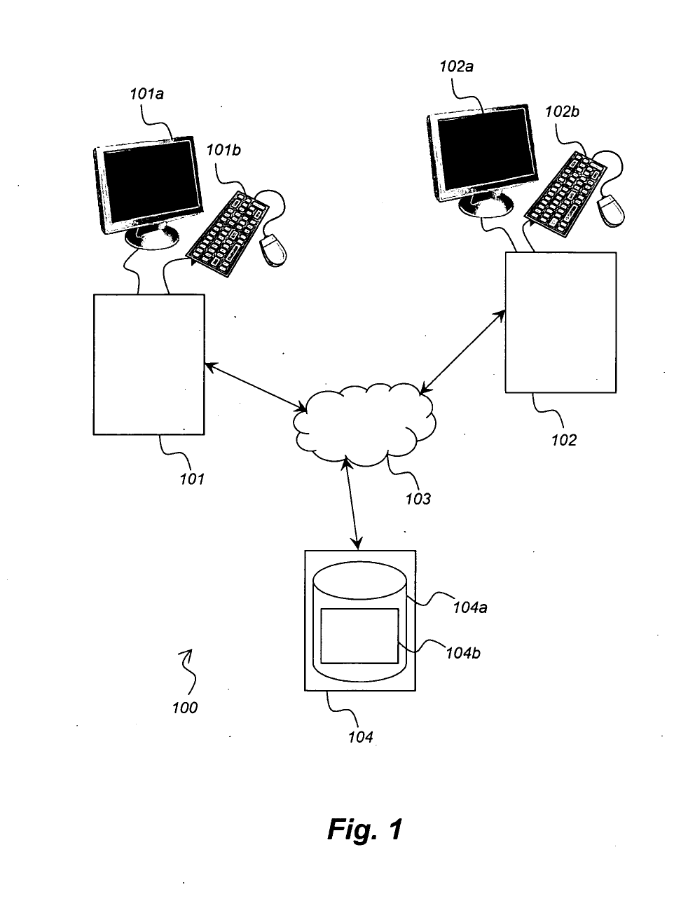

FIG. 1 shows a conventional CDS trading system 100 of the prior art. A first processing device 101 and a second processing device 102 are connected via a conventional network connection 103, such as a LAN and the Internet, to each other and can communicate with each other over the network connection 103. A server processing device 104 is also connected to the network connection 103 and is accessible to both the first and second processing devices 101, 102. In one example of the prior art, the first processing device 101 may be accessed by a first user (acting for a given institution) who is a buyer of credit default swaps and the second processing device 102 may be accessed by a second user (acting for a given institution) who is a seller of one or more credit default swaps, but the opposite is also true and the first user may also be a seller of credit default swaps and the second user may be a buyer of credit default swaps. In essence, the first and second processing devices 101, 102 are interchangeable in that each can operate as both a sales and purchase platform for credit default swaps.

The first processing device 101 is connected to a first display screen 101a and first user input means 101b. The second processing device 102 is connected to a second display screen 102a and second user input means 102b.

The server processing device 104 comprises memory 104a storing a database 104b of the credit default swaps which are tendered for sale or purchase by the second processing device 104. For each credit default swap which is tendered by a given processing device, the database 104b comprises an offered sale price and an offered purchase price for a unit value of the CDS.

The second processing device 102 is configured to transmit sale and purchase prices of credit default swaps to the server processing device 104 for storage in the database 104b. In essence, a user of the second processing device 102 has agreed to sell a given CDS at a particular unit sale price and purchase a given CDS at a particular unit purchase price.

When a user of the first processing device 101 wishes to instigate a trade of a CDS, the first processing device 101 is directed (using the first user input means 101b) to access the server processing device 104 and a request for available credit default swaps from the second processing device 102 is transmitted. The server processing device 102 receives the request and transmits the purchase and sale prices for the credit default swaps. The sale and purchase prices are received by the first processing device 101 and displayed in a user interface on the first display screen 101a or vice versa. The server processing device 104 acts merely to receive, store and pass on sale and purchase prices of credit default swaps. The user of the first processing device 101 may decide to proceed with a trade (either sale or purchase) based on the received purchase and sale prices. The trade is then effected using the first user input means 101b through the first processing device 101 which initiates communication directly with the second processing device 102 corresponding to the CDS which it is intended to trade. An electronic swap contract is exchanged directly between the first and second processing devices 101, 102. In the prior art, the server processing device 102 acts merely to pass on the sale and purchase prices of credit default swaps agreed by a particular institution through the second processing device 102. The institution will only permit a user of the first processing device 101 to trade with it when it has accepted that the user (or related institution) has sufficient available credit with the counter party and vice versa. In the prior art system 100, this is achieved by the second processing device 102 being configured to restrict access to a group of accepted users receiving direct connections from the first processing device 101.

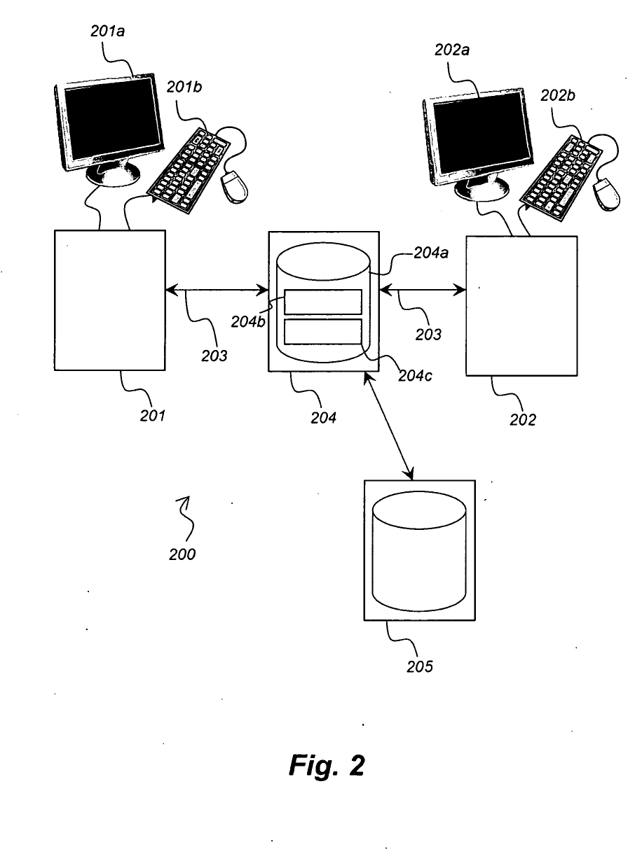

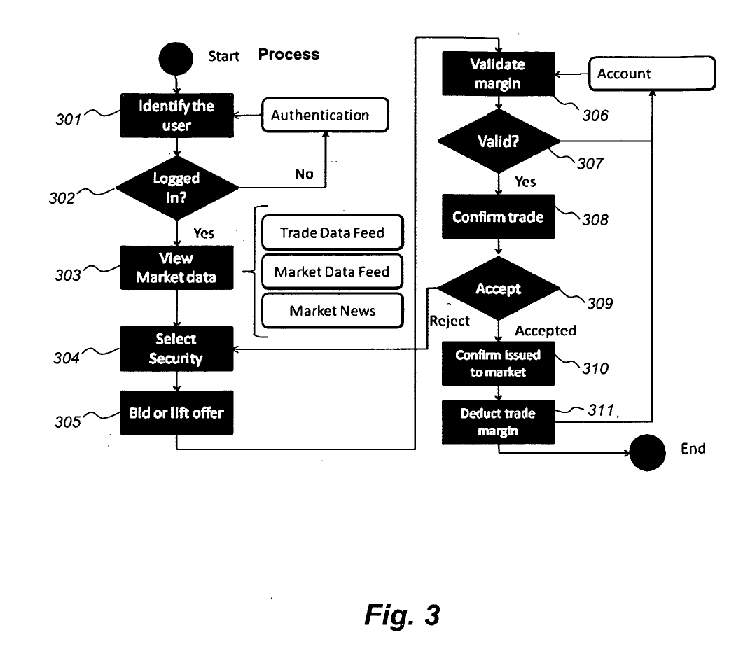

FIG. 2 shows a trading system 200 according to the present invention and FIG. 3 shows a workflow performed by the system 200 of the present invention. The invention is now described by way of example only, with regard to FIGS. 2 and 3.

A client processing device 201 and a tender processing device 202 are connected via a conventional network connection 203, such as a LAN and the Internet, to each other and can communicate with each other over the network connection 203. A server processing device 204 is also connected to the network connection 203 and is accessible to both the tender and client processing devices 201, 202. The client processing device 201 is accessible by a user who is a buyer of credit default swaps and the tender processing device 202 operates with or for an institution (such as a market maker) who is a seller of one or more credit default swaps. The opposite is also true and the user may also be a seller of credit default swaps and the institution may be a buyer of credit default swaps. The institution is commonly known as a market maker and the user is commonly known as a trader. In both cases, the tender processing device 202 supports tenders to buy or sell credit default swaps and the client processing device 201 serves as a platform to respond to the tenders, rather than providing its own tenders. That is to say, the client processing 201 is not accessible by any other device to view credit default swap prices, whereas the tender processing device 202 transmits and receives sale and purchase prices for credit default swaps across the network connection 203 to the server processing device 204.

The client processing device 201 is connected to a client display screen 201a and client user input means 201b. The tender processing device 202 is connected to a tender display screen 202a and tender user input means 202b.

The server processing device 204 comprises memory 204a storing a CDS database 204b of the credit default swaps which are tendered for sale or purchase by the tender processing device 202. For each credit default swap which is tendered by a particular processing device 201, the CDS database 204b comprises an offered sale price and an offered purchase price for a unit value of the CDS.

The memory 204a also comprises a user database 204c of user information containing a record for each registered user of the system 200, a value representing cash credit available to the user and a credit rating for the registered user; that is a value representing the credit worthiness of the user and the ability of the user to make payments required under the terms of a credit default swap.

The aforementioned cash credit can be an amount that the supplier of the system 200 is willing to loan on margin in addition to a user's personal credit contained in a margin account. A user has to have a minimum amount in the margin account for the purchase of a particular CDS. This deposit is known as the minimum margin. From the account, the user can borrow from the system provider up to a specified percentage (e.g. 60%) of the notional purchase value of the credit default swap. On completion of a purchase of a CDS, the margin loaned to the user by the system provider is secured against the CDS so that, on sale of the CDS by the user, the amount of the margin is first repaid to the system provider before the remainder of the value from the sale of the CDS is credited to the user into the margin account. The server processing device 204 determines the margin available to the user for the purchase of a given CDS based on the specified percentage defined by the supplier and a minimum margin required by the supplier. The margin account is held at payment clearance server 205 which also holds the system provider's account for providing the margin as determined and approved by the server processing device 204. The payment clearance server 205 is connected to the server processing device 204.

The minimum margin and specified percentage are specific to a particular user and values for each user are stored in the user database 204c.

The tender processing device 202 is configured to transmit sale and purchase prices of credit default swaps to the server processing device 204 for storage in the database 204b. In essence, the institution represented by the tender processing device 202 has agreed to sell a given CDS at a particular unit sale price and purchase a given CDS at a particular unit purchase price. Tendered data is transmitted from the tender processing device 202 to the server processing device 204 comprising: sale and purchase prices along with an identifier for the particular CDS and credit conditions which must be satisfied by the buyer or seller for a trade to be completed. This information is displayed in a user interface generated by the client processing device and displayed on the client display screen 201a. For example, the credit conditions may stipulate that the seller must have a particular value or range of credit worthiness values.

In step 301, the user accessing the client processing device 201 with client user input means 201b directs the client processing device 201 to connect to the server processing device 204 and identifies itself to the server processing device 204, for example by logging in with a username and password to the server processing device 204; that is the client processing device 201 receives input of the username and password from the client processing device 201 and transmits the username and password to the server processing device 204. If, following step 302, the user is identified in the user database 204c, then in step 303, the tendered prices stored in the CDS database 204b, and received from the tender processing device 202, are streamed and updated in real-time to the client processing device 201. The server processing device 204 is configured to transmit only the ‘best’ sale and purchase prices for a particular CDS to the client processing device 201 from amongst a plurality of values of a particular CDS received from different institutions and tender processing device 202s. In a particular embodiment of the invention, the ‘best’ price is defined as the lowest sale unit sale price for a given CDS or the highest purchase price for a given CDS. Thus, the server processing device 204 transmits sale and purchase prices for different available credit default swaps which are received from a plurality of different tender processing devices (only one tender processing device is shown in FIG. 2).

In step 304, the user of the client processing device 201 may decide to proceed with a trade (either sale or purchase) of a given CDS from the counter party based on the received purchase and sale prices. Using the client user input means 201b, the trade is initiated by the client processing device 201 initiating communication with the server processing device 204 to transmit a trade request for a quantity of sale or purchase of the selected CDS.

In step 306, the server processing device 204 receives the trade request and determines the value of the trade; that is the total purchase or sale cost to the user of the client processing device 201. In step 307, the server processing device 204 is configured to access the client database 204b and determine whether the identified user has sufficient credit margin and satisfies the credit conditions specified in the tendered data previously transmitted from the tender processing device 202.

In the case of purchase of a CDS by a user, the server processing device 204 communicates with the payment clearance server 205 to determine whether sufficient margin credit exists for the trade. In doing this, the server processing device 204 determines that:
(i) sufficient personal credit is available to the user in its margin account;
(ii) sufficient margin (provided by the system provider) is available in addition to the user's personal credit above the user's specified maintenance margin; and
(iii) the margin being supplied is below the maximum specified percentage available to the user for the trade of the particular CDS.

If sufficient margin credit exists and the credit conditions for the particular CDS trade are satisfied, then the tender processing device 202 which offered the sale or purchase price for the tendered processing device is notified, along with the client processing device 201 which instigated the trade (step 308). In step 308, the notification gives the user of the client processing device 201 a further opportunity to cancel or accept the trade. If the conditions are not satisfied or insufficient credit does not exist then the tender processing device 202 and client processing device 201 are notified accordingly.

If, following step 309, the trade is to be accepted, then the server processing device 204 generates an electronic swap contract for the trade (i.e. either a sale or purchase by the client processing device 201) in step 310 and submits an electronic payment request to the payment clearance server 205 in respect of the institution corresponding to the tender processing device 202 (in the case of sale by the institution) or in respect of the user identified at the client processing device 201 (in the case of sale by the user).

In the case of purchase of a CDS by a user, the server processing device 204 signals the payment clearance server 205 in the request to transfer credit from the user's margin account to the institution's account along with any margin credit required and approved from the system provider's account. In the case of sale of a CDS by a user, the server processing device 204 signals the payment clearance server 205 in the request to transfer credit from the institution's margin account to the system provider's account in respect of margin previously utilised by the user for its purchase of the CDS, and to further transfer any remaining credit owed (having been deducted from the margin owed to the system provider) into the user's margin account.

In addition, in step 311, a trade margin or trade fee is deducted by the server processing device 204 and credited to the system provider's account.

The swap contract is completed during step 310 by being electronically signed by the server processing device 204 on behalf of both the user and institution and transmitted to both the client and tender processing devices 201, 202.

The electronically signed swap contract represents agreement that the seller receives a payment if the credit instrument specified in the swap contract goes into default or a specified credit event occurs.

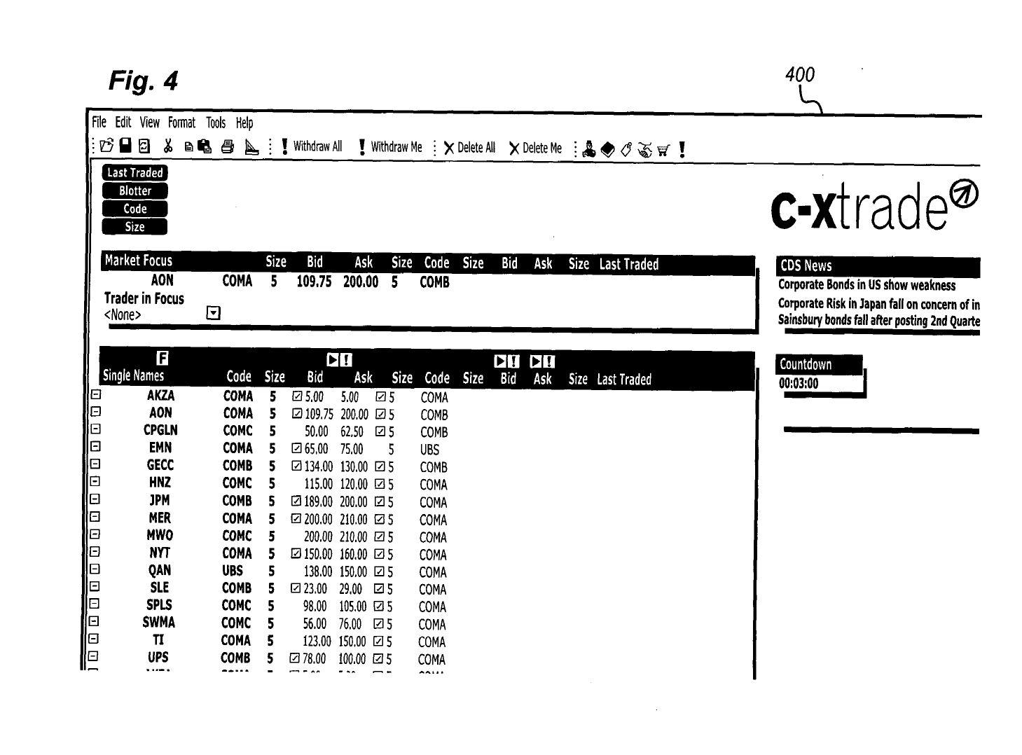

FIG. 4 shows a user interface 400 of the trading system 200 generated by the client processing device 201 on the client display screen 201a based on the tender data received from the server processing device 204.

It will of course be understood that the present invention has been described above purely by way of example and modifications of detail can be made within the scope of the invention.

1. A system for facilitating the exchange of credit default swaps, comprising:
a plurality of tender processing devices, each comprising a tender storage medium including instrument data representative of a tendered credit instrument being offered for sale by a seller or purchase by a buyer and an offer price for said tendered credit instrument;
a server processing device connected to each of the tender processing devices and comprising a server storage medium;
a client processing device connected to the server processing device and configured to identify one of a plurality of users accessing the client processing device,
wherein the server storage medium comprises user data representative of a credit margin available to each of the plurality of users,
wherein the server processing device is configured to receive the data representative of said tendered credit instrument and offer price from each of the tender processing devices,
wherein the server processing device is configured to transmit the data representative of the tendered credit instruments and corresponding offer prices to the client processing device,
wherein the server processing device is configured to receive a request from the client processing device representative of a purchase or sale by the identified user of a selected quantity of one of the tendered credit instruments,
wherein the server processing device is configured to determine from the user data corresponding to the identified user of the client processing device whether sufficient credit is available to the identified user for the purchase of the selected quantity of the tendered credit instrument;
if sufficient credit for the identified user does exist, the server processing unit is configured to complete the transfer of the selected tendered credit instrument by instructing a payment clearance of the payment transaction, electronically signing an electronic credit default swap contract on behalf of the user and the buyer or seller of the tendered credit instrument and transmitting the credit default swap contract to the tender processing device and client processing device.

2. The system of claim 1, wherein the server processing device is configured to identify data of a plurality of matching credit instruments from the plurality of tender processing devices and transmit to the client processing device only data representative of the credit instrument having the lowest offer price, in the case of sale, from the plurality of matching credit instruments and transmit to the client processing device only data representative of the credit instrument having the highest offer price, in the case of purchase, from the plurality of matching credit instruments.

3. The system of claim 1, wherein the client processing device is configured to display on a display screen the data representative of the tendered credit instruments and corresponding offer prices and receive an input from the identified user of a selected quantity of one of the tendered credit instruments, thereby generating the request representative of the desired purchase by the identified user.

4. The system of claim 1, wherein the payment transaction corresponds to a currency amount that is less than 1 million United States dollars.

5. The system of claim 1, wherein the server processing unit is configured to send the payment transaction for the benefit of the seller for the amount of the purchase of the selected credit transaction with a deduction for a trade margin.

6. The system of claim 1, wherein the credit comprises margin credit including a user's personal credit and additional margin provided by a provider of the server processing device.

7. The system of claim 1, wherein the server processing device is further configured to determine from the user data and the data representative of the tendered credit instruments corresponding to the selected credit instrument whether the identified user satisfies credit conditions required by the selected credit instrument, and, if not, preventing completion of the transfer of the selected credit instrument.

8. A method for facilitating the exchange of credit default swaps, comprising:
identifying a one of a plurality of users accessing a client processing device;
receiving, at a server processing device, data representative of tendered credit instruments and offer prices from a plurality of tender processing devices, each comprising a tender storage medium including instrument data representative of a tendered credit instrument being offered for sale by a seller and an offer price for said tendered credit instrument;
transmitting the data representative of the tendered credit instruments and corresponding offer prices to the client processing device from the server processing device;
receiving from the client processing device at the server processing device a request representative of a purchase by the identified user of a selected quantity of one of the tendered credit instruments;
at the server processing device, determining from user data corresponding to the identified user of the client processing device and stored in a server storage medium whether sufficient credit is available to the identified user for the purchase of the selected quantity of the tendered credit instrument; and
if sufficient credit for the identified user does exist, at the server processing device, transferring the selected tendered credit instrument by instructing a payment clearance of the payment transaction, electronically signing an electronic credit default swap contract on behalf of the user and the buyer or seller of the tendered credit instrument and transmitting the credit default swap contract to the tender processing device and client processing device.

9. The method of claim 8, further comprising the step of identifying data of a plurality of matching credit instruments from the plurality of tender processing devices and transmitting to the client processing device only data representative of the credit instrument having the lowest sale price from the plurality of matching credit instruments and transmitting to the client processing device only data representative of the credit instrument having the highest sale price from the plurality of matching credit instruments

10. The method of claim 8, further comprising displaying on a display screen of the client processing device the data representative of the tendered credit instruments and corresponding offer prices and receiving an input from the identified user of a selected quantity of one of the tendered credit instruments, thereby generating the request representative of the desired purchase by the identified user.

11. The method of claim 8, wherein the payment transaction corresponds to a currency amount that is less than 1 million United States dollars.

12. The method of claim 8, wherein the step of sending the payment transaction comprises sending the payment transaction for the benefit of the seller for the amount of the purchase of the selected credit instrument with a deduction for a trade margin.

13. The method of claim 8, wherein the credit comprises margin credit including a user's personal credit and additional margin loaned by a provider of the server processing device.

14. The method of claim 8, further comprising the server processing device determining from the user data and the data representative of the tendered credit instruments corresponding to the selected credit instrument whether the identified user satisfies credit conditions required by the selected credit instrument, and, if not, preventing completion of the transfer of the selected credit instrument.

15. A carrier comprising computer executable instructions for performing the method of claim 8.
